(19) United States
(12) Patent Application Publication
(10) Pub. No.: US 2004/0200681 A1
(43) Pub. Date: Oct. 14, 2004

(54) Sealing arrangement for an oscillating motor

(75) Inventor: Andreas Forster, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/816,023

(22) Filed: Apr. 1, 2004

(30) Foreign Application Priority Data
Apr. 9, 2003 (DE) 103 16 147.3

(51) Int. Cl. B60J 1/00; B60N 2/00

(52) U.S. Cl. 188/293; 188/296

(57) ABSTRACT

Sealing arrangement for an oscillating motor, comprising a housing, in which a motor shaft is supported with freedom to rotate, where the housing and the motor shaft form at least one working chamber filled with a pressure medium, the chamber being sealed off with respect to the motor shaft by the seal, which is located in a sealing groove, The seal has a one-piece sealing body, one side of which rests against the base of a groove in the housing, whereas the other side rests against the motor shaft, where the one-piece sealing body has an anti-rotation device which prevents it from turning with respect to the housing.

### BACKGROUND OF THE INVENTION

1. Field of the Invention

The invention pertains to a sealing arrangement for an oscillating motor having a housing in which a motor shaft is supported for rotation, the housing and the shaft forming at least one working chamber filled with a pressure medium, wherein the chamber is sealed by a seal located in a sealing groove.

2. Description of the Related Art

U.S. Pat. No. 5,791,444 discloses an oscillating motor having a seal installed in a groove in the housing at each end to seal off the working chambers in the housing. The seal must fulfill highly incompatible functions. First, it must ensure the sealing function over a temperature range extending from −40° C. to at least +120° C. Sealing materials almost always contain at least certain amounts of plastic, which means that it is necessary to take into account a comparatively large amount of thermal expansion of the seal. One of the possible ways in which this fundamental disadvantage can be compensated is to increase the pretension on the seal to such an extent that the sealing function is still guaranteed even at low temperatures. At higher temperatures, however, a great deal of friction will then occur between the seal and the shaft of the oscillating motor and/or the groove in the housing. Especially when the oscillating motor is operated without pressure, e.g., during straight-ahead travel, friction within the oscillating motor has the effect of reducing the comfort of the ride.

The seal described in U.S. Pat. No. 5,791,444 includes an outer and an inner sealing body, which are pretensioned against each other across a conical contact surface in conjunction with a spring. There is necessarily some axial movement, the extent of which depends on the coefficient of friction, and there is also relative movement in the circumferential direction between the two sealing bodies. In addition, the outer sealing body is also able to shift axially, at least within certain limits, with respect to the base of the groove in the housing.

### SUMMARY OF THE INVENTION

The task of the present invention is to develop a seal for an oscillating motor with which it is possible to achieve both low friction and a reliable sealing function at the same time.

This task is accomplished according to the invention in that the seal has a one-piece sealing body, one side of which rests against the base of a groove in the housing, whereas the other side rests against the motor shaft, where the one-piece sealing body has a device which prevents it from rotating with respect to the housing.

It was found on the basis of numerous experiments that one of the essential causes of leakage is the undefined relative movement of the sealing body with respect to the base of the groove. The sealing function of the seal is significantly improved by the one-piece design of the sealing body and the additional anti-rotation device.

So that the sealing body can be pretensioned in such a way as to obtain an operating behavior which, especially with respect to the frictional force, tends to be less dependent on temperature, the sealing body is pretensioned by a tension ring against the base of the groove. This ensures a more constant pretension, and also minimizes the danger of deformation of the sealing body in the groove during assembly.

In a further advantageous embodiment, the tension ring extends over an angle of more than 360°. Thus, even in the case of a split tension ring, the entire sealing surface of the sealing body can be pretensioned against the base of the groove.

According to an advantageous embodiment, the tension ring acts on a surface of the sealing body which is at an angle to the base of the groove and also to a side surface of the groove. There are thus two separate friction surfaces in contact with the sealing body, as a result of which the pretensioning force of the tension ring can be increased without changing the given pressure per unit surface area.

Depending on the pretensioning force of the tension ring, a support ring can be provided to make sure that the force of the tension ring is introduced uniformly into the sealing body.

Alternatively or in combination with the tension ring, the sealing body can have a certain area with a different diameter, which cooperates with a stop profile in the sealing groove to prevent the sealing body from turning.

So that the sealing groove can be produced easily, the stop profile in the sealing groove is formed by a pocket.

As for the sealing body, it is provided with a limited circumferential area of larger diameter. It is advantageous for there to be a generous amount of play for the sealing body in the pocket in the sealing groove in both the radial direction of the area of increased diameter and the axial direction, i.e., the direction of the longitudinal axis, because this minimizes the chances of a deformation of the area of the sealing body with a different diameter.

So that the installation position of the sealing body can be found as easily and as correctly as possible during the assembly procedure, one of the sidewalls of the groove has a recess to allow the passage of the area of the sealing body with the increased diameter. The assembler or assembly robot can thus introduce the sealing body into the correct assembly position in the sealing groove with almost no possibility of error.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a cross-sectional view of a hydraulic oscillating motor;

FIGS. 2-5 are cross-sectional views of embodiments of the seal with a tension ring;

FIG. 6 is an axial section of an anti-rotation device formed by the positive engagement between the sealing body and the sealing groove; and

FIG. 7 is a side section or the device of FIG. 6.

### DETAILED DESCRIPTION OF THE PRESENTLY PREFERRED EMBODIMENTS

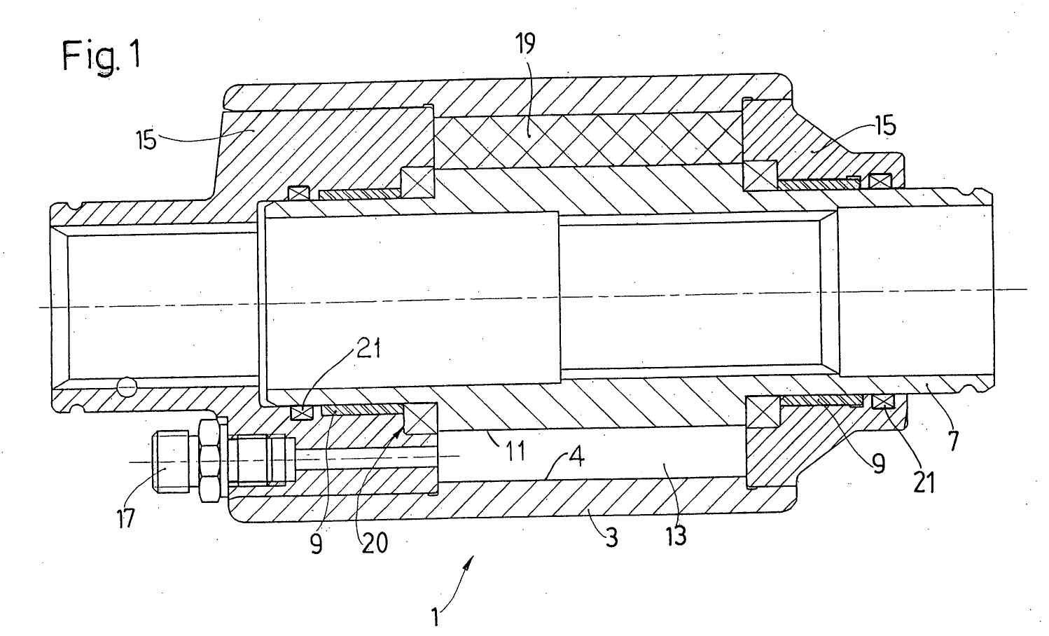

FIG. 1 shows a cross-sectional diagram of a hydraulic oscillating motor, which consists essentially of a housing 3, which has at least one rib 4 on its inside wall. Inside the housing 3 there is a motor shaft 7, supported by bearings 9. The motor shaft has on its outside lateral surface at least one axially oriented vane 11, so that the motor shaft 7, with its vane 11, and the housing 3 with its rib 4, form at least one working chamber 13, which is sealed off at the ends by covers 15. A hydraulic supply line 17 is provided in one of the covers. The minimum of one working chamber is separated hydraulically by a flat seal 19 in the rib and the vane. In addition, the oscillating motor also has seals 20, which seal off the working chamber from the outside. The entire oscillating motor is sealed off by seals 21 between the housing 3 and the motor shaft 7 from the outside environment.

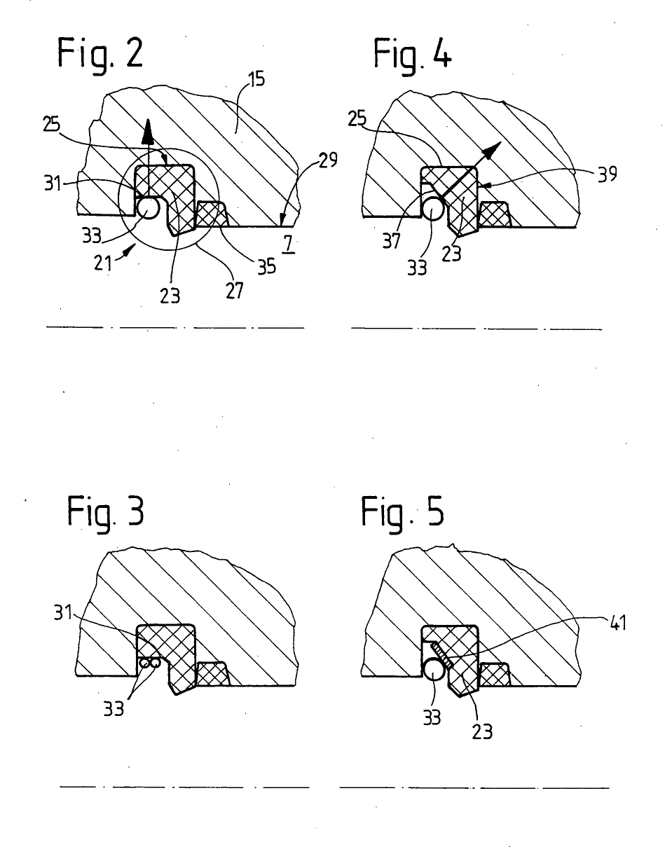

FIG. 2 is limited to a section of the cover 15 in the area of the seal 21. The seal 21 has a one-piece sealing body 23, which extends from the base 25 of a sealing groove 27 all the way to the lateral surface 29 of the motor shaft and has essentially an L-shaped cross section. On a shoulder 31 of the sealing body 23 there is a split tension ring 33 which exerts a pretensioning force on the sealing body 23 in the direction toward the base 25 of the groove. The pretensioning force prevents the sealing body 23 from turning with respect to the sealing groove 27. The sealing body can also be provided with a support body 35, which is intended to absorb the force acting on the sealing body 23 produced by the working pressure in the working chamber 13 and thus to prevent the sealing body from flowing into the gap between the cover 15 and the motor shaft 7. The support body does not serve any sealing function.

In contrast to FIG. 2, FIG. 3 shows a split tension ring 33 which extends around an angle of more than 360°, which is symbolized by the two wire cross sections. Thus a closed pretensioning force is achieved over the entire circumferential area of the shoulder 31 of the sealing body.

FIGS. 4 and 5 illustrate a variant of the sealing body, which now has a surface 37, which is at an angle to the base 25 of the groove and to a side surface 39 of the groove, preferably the side closer to the outside surface of the cover. The tension ring 33 acts on this slanted surface and thus exerts a radial pretensioning force on the base 25 of the groove and an axial pretensioning force on the side surface 39. The two groove surfaces 25; 39 each represent a friction surface, so that the pressure per unit area between the sealing body and the sealing groove is lower than that present in the design according to FIGS. 2 and 3. For the same allowable pressure per unit area, it is therefore possible to use a stronger tension ring 33. To protect the sealing body, the tension ring can be provided with a support ring 41 if desired.

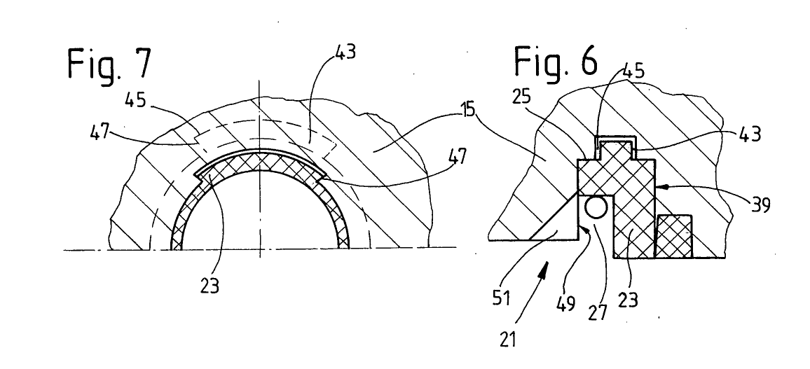

FIGS. 6 and 7 show an exemplary embodiment of an inventive seal 21 with an anti-rotation device, consisting of a partial area of the sealing body 23 with a different diameter, especially an area of increased diameter 43, and a stop profile in the sealing groove in the form of a pocket 45. The area of increased diameter is limited in the circumferential direction, so that the web can fit into the pocket. The terminal surfaces 47 of the pocket effectively prevent the sealing body from turning in the circumferential direction inside the sealing groove. To minimize the danger that the sealing body could be squeezed out of shape inside the sealing groove in the event that it were to be installed incorrectly in the circumferential direction, the pocket can be larger in the axial direction and in the radial direction than would be necessary to accept the area of increased diameter of the sealing body.

As can be seen in FIG. 6, the sidewall 49 of the groove, i.e., the side from which the assembly operation proceeds, is provided with a recess 51, which is at least as large in the circumferential direction as the area of increased diameter of the sealing body. This facilitates the assembly work by making it much easier to find the correct position in which to install the sealing body.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A sealing arrangement for an oscillating motor, the sealing arrangement comprising:
a shaft;
a housing which supports the motor shaft with freedom to rotate, the housing and the motor shaft forming at least one working chamber filled with pressure medium, the housing having a sealing groove with a radially extending sidewall and a radially inward facing base;
a seal comprising a one part sealing body received in the groove, the sealing body having one side resting against the bas and another side resting against the shaft; and
an anti-rotation device which prevents the sealing body from rotating with respect to the housing.

2. A sealing arrangement as in claim 1 further comprising a tension ring pretensioning the sealing body against the base of the groove.

3. A sealing arrangement as in claim 2 wherein the tension ring extends around an angle of over 360 degrees.

4. A sealing arrangement as in claim 2 wherein the sealing body has a surface which extends at an angle intermediate the sidewall and the base of the groove, the tension ring acting on the surface of the sealing body.

5. A sealing arrangement as in claim 4 further comprising a support ring on the surface of the sealing body, the tension ring resting on the support ring.

6. A sealing arrangement as in claim 1 wherein the anti-rotation device comprises:
a stop profile in the sealing groove; and
an area of increasing diameter of the sealing body, the area of increased diameter cooperating with the stop profile to prevent the sealing body from rotating with respect to the housing.

7. A sealing arrangement as in claim 6 wherein the stop profile comprises a radial pocket in the base of the sealing groove.

8. A sealing arrangement as in claim 6 wherein the sealing body has an area of increased diameter which is circumferentially limited.

9. A sealing arrangement as in claim 8 wherein the sidewall has a recess to allow passage of the area of increased diameter.
